(19) United States
(12) Patent Application Publication
(10) Pub. No.: US 2021/0390551 A1
(43) Pub. Date: Dec. 16, 2021

(54) INTELLIGENT TRANSACTION PRE-AUTHORIZATION USING A BROWSER EXTENSION

(71) Applicant: Capital One Services, LLC, McLean, VA (US)

(72) Inventors: Jonatan Yucra Rodriguez, San Francisco, CA (US); Blake Wills, San Francisco, CA (US); John Kim, Dublin, CA (US)

(73) Assignee: Capital One Services, LLC, McLean, VA (US)

(21) Appl. No.: 16/901,104

(22) Filed: Jun. 15, 2020

(51) Int. Cl. G06Q 20/40; H04L 29/06; G06Q 30/06; G06Q 20/34; G06Q 20/42; G06Q 20/08; G06F 16/838; G06F 3/0484

(52) U.S. Cl. CPC G06Q 20/40145; H04L 63/083; H04L 63/0861; G06Q 30/0641; G06Q 20/4018; G06Q 2220/00; G06Q 20/42; G06Q 20/085; G06F 16/838; G06F 3/04842; H04L 2463/082; G06Q 20/34

(57) ABSTRACT

A computer-implemented method may be used for intelligent transaction pre-authorization using a browser extension. The method may including detecting user navigation by a user of a vendor web page, the vendor web page being associated with a vendor and detecting at least one input field of the vendor web page. Additionally, the method may include determining based on the at least one input field of the vendor web page, that the user is attempting a transaction with the vendor and determining information regarding the vendor based on the vendor web page. Additionally, the method may include executing a program to display on the vendor web page a request for the user to pre-authorize the transaction prior to completing the transaction and receiving, by the one or more processors, an indication from the user to pre-authorize the transaction. Additionally, the method may include receiving payment information of the user and processing the transaction between the user and the vendor.

### TECHNICAL FIELD

Various embodiments of the present disclosure relate generally to providing assistance to transactions between a purchaser and a vendor, and more specifically to online transactions where authorization may be necessary to finalize the transaction.

### BACKGROUND

Purchasers of entertainment items, such as tickets to sporting events, concerts, movies, festivals, etc. may conduct part or all of their shopping for such items online, via the Internet. In attempting to complete such a purchase, a purchaser may visit multiple vendor websites in search of appropriate information. For example, consumers may visit a vendor website to purchase tickets for an international sporting event or a vendor website to plan for travel. When the purchaser wants to complete the purchase, the purchaser may enter information of a financial instrument issued by an issuer, for example a credit card. However, if the vendor is located in another country from the purchaser, or if the transaction deviates from normal spending habits of the purchaser, such as a new vendor or high cost of an item, a fraud alert might be set off and the purchaser may be prompted to confirm the purchase. The purchaser may confirm the purchase via a text message, an e-mail, an application notification, or a phone call with the issuer. However, due to the time sensitiveness of certain entertainment items, the time taken for the purchaser to confirm the purchase may result in the purchaser not being able to purchase the items (e.g., sporting event sold out).

Furthermore, even if the purchaser is able to purchase the items the extra time and steps needed for the purchaser to contact the issuer to confirm the purchase may lead to a negative experience for the purchaser and association of the issuer with the negative experience.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY

According to certain aspects of the disclosure, non-transitory computer readable media, systems, and methods are disclosed for establishing pre-authorization of one or more transactions. Each of the examples disclosed herein may include one or more of the features described in connection with any of the other disclosed examples.

In one example, a computer-implemented method for pre-authorization, may include detecting, by one or more processors, user navigation by a user of a vendor web page, the vendor web page being associated with a vendor; detecting, by the one or more processors, at least one input field of the vendor web page; determining, by the one or more processors, based on the at least one input field of the vendor web page, that the user is attempting a transaction with the vendor; determining, by the one or more processors, information regarding the vendor based on the vendor web page; executing, by the one or more processors, a program to display, on the vendor web page, a request for the user to pre-authorize the transaction prior to completing the transaction; receiving, by the one or more processors, an indication from the user to pre-authorize the transaction; receiving, by the one or more processors, payment information of the user; and processing, by the one or more processors, the transaction between the user and the vendor.

According to another aspect of the disclosure, a computer system for pre-authorization may include at least one memory having processor-readable instructions stored therein; and at least one processor configured to access the memory and execute the processor-readable instructions, which when executed by the processor configures the processor to perform a plurality of functions. The functions may include detecting, by one or more processors, user navigation by a user of a vendor web page, the vendor web page being associated with a vendor; detecting, by the one or more processors, at least one input field of the vendor web page; determining, by the one or more processors, based on the at least one input field of the vendor web page, that the user is attempting a transaction with the vendor; determining, by the one or more processors, information regarding the vendor based on the vendor web page; executing, by the one or more processors, a program to display, on the vendor web page, a request for the user to pre-authorize prior to completing the transaction; receiving, by the one or more processors, an indication from the user to pre-authorize the transaction; receiving, by the one or more processors, payment information of the user; and processing, by the one or more processors, the transaction between the user and the vendor.

In another aspect of the disclosure, a computer-implemented method for pre-authorization may include installing, by one or more processors, a browser extension on a web browser of a user device associated with a user; detecting, by the one or more processors, at least one input field on a web page of a vendor; determining, by the one or more processors, based on the at least one input field of the web page that the user is attempting a transaction with the vendor; determining, by the one or more processors, information regarding the vendor based on the web page; determining, based on the at least one input field and the vendor information, a likelihood that the transaction will be declined; upon determining that the likelihood that the transaction will be declined exceeds a threshold likelihood, executing, by the one or more processors, the browser extension to request the user to pre-authorize the transaction with an issuer while remaining on the web page of the vendor; receiving, by the one or more processors, permission from the user to pre-authorize the transaction; receiving, by the one or more processors, payment information of the user; and finalizing, by the one or more processors, the transaction between the user and the vendor.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment in which systems, methods and other aspects of the present disclosure may be implemented.

FIGS. 2A-2C depict exemplary user interfaces for transaction pre-authorization using a browser extension, according to one aspect of the present disclosure.

FIGS. 3 and 4 depict exemplary flow diagrams of transaction pre-authorization methods using a browser extension, according to aspects of the present disclosure.

FIG. 5 depicts an exemplary computer device or system, in which embodiments of the present disclosure, or portions thereof, may be implemented.

### DETAILED DESCRIPTION

The subject matter of the present description will now be described more fully hereinafter with reference to the accompanying drawings, which form a part thereof, and which show, by way of illustration, specific exemplary embodiments. An embodiment or implementation described herein as “exemplary” is not to be construed as preferred or advantageous, for example, over other embodiments or implementations; rather, it is intended to reflect or indicate that the embodiment(s) is/are “example” embodiment(s). Subject matter can be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware, or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of exemplary embodiments in whole or in part.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The term “or” is meant to be inclusive and means either, any, several, or all of the listed items. The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In the following description, embodiments will be described with reference to the accompany drawings. Various embodiments of the present disclosure relate generally to methods and systems for enabling pre-authorization for legitimate transactions with a likelihood of decline by a financial instrument issuer that exceeds a predetermined threshold. For example, various embodiments of the present disclosure relate to determining an attempt of a user to conduct a transaction with a vendor. In some arrangements, an installed browser extension may request the user to pre-authorize the transaction to prevent the transaction being declined by the issuer due to fraud checks.

As described above, in order to process legitimate transactions with high likelihood of decline by a financial instrument issuer, the user may need to request authorization for the transaction. If the request is sent to the user after the user submits the transaction, the user may not have enough time to verify the authorization before the product or service is sold out. If the transaction is processed by the issuer without an authorization from the user, then the user may be subjected to fraudulent transactions. Further, users may complete the transaction without realizing the need to inform the issuer of the transaction. Therefore, a need exists to provide users the ability to pre-authorize the transaction before the transaction is processed by the issuer.

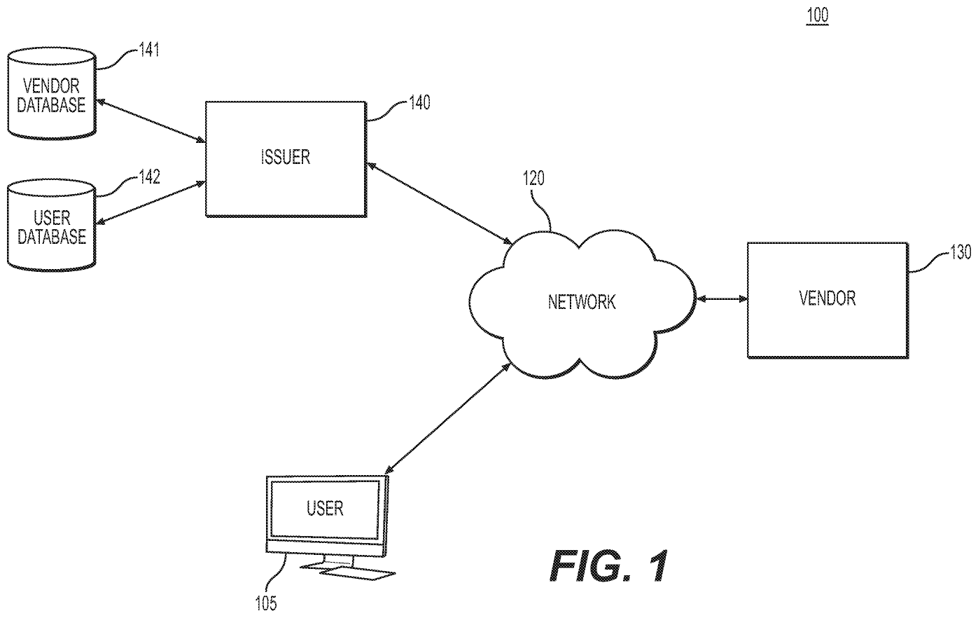

Referring now to the appended drawings, FIG. 1 depicts an exemplary environment 100 for intelligent transaction pre-authorization using a browser extension. Environment 100 may include one or more user devices 105, network 120, at least one vendor 130, issuer 140, vendor database 141, and user database 142 . The user device 105, the vendor 130, and the issuer 140 may be connected via network 120. Network 120 may be any suitable network or combination of networks and may support any appropriate protocol suitable for communication of data between various components in the system environment 100. The network 120 may include a public network (e.g., the Internet), a private network (e.g., a network within an organization), or a combination of public and/or private networks.

The user device 105 may be operated by one or more users to perform purchases and transactions at an online environment. Examples of user device 105 may include smartphones, wearable computing devices, tablet computers, laptops, desktop computers and vehicle computer systems.

The at least one vendor 130 may be one or more entities that provide products. In this disclosure, the term “product,” in the context of products offered by a merchant, encompasses both goods and services, as well as products that are a combination of goods and services. A vendor may be, for example, a sports organization, an entertainment promoter, travel providers, a retailer, or other type of entity that provides products that a user may purchase. A vendor may also, for example, operate one or more websites that may include virtual shopping carts that a user may access to conduct purchases.

Issuer 140 may be an entity such as a bank, credit card issuer, merchant services providers, or other types of financial service entity. In some examples, issuer 140 may include one or more merchant services providers that provide vendor 130 with the ability to accept electronic payments, such as payments using credit cards and debit cards. In other examples, issuer 140 may include one or more merchant services providers that provide vendor 130 with the ability to process financial loans, such as vehicle loans. Therefore, issuer 140 may collect and store transaction data pertaining to consumer transactions occurring at the vendor 130.

Vendor database 141 may include previous transaction data between vendors and users. Previous transaction data may include transactions that are both successful and unsuccessful. Successful transactions may be transactions that resulted with the purchaser completing the purchase. Unsuccessful transactions may be transactions that did not result in the purchaser completing the purchase. Vendor database 141 may also include information related to products or services offered by the vendor, location of vendor, and fraudulent transactions associated with the vendor. The issuer 140 may use historical data or machine learning to populate the vendor database 141. User database 142 may include information regarding each user (e.g., user-specific information). For example, previous purchase history, categories of goods or services purchased by the user, fraudulent transactions associated with the user, and vendors whitelisted by the user. Users may whitelist vendors to indicate to the issuer 140 that pre-authorization is not needed when making purchases from a whitelisted vendor.

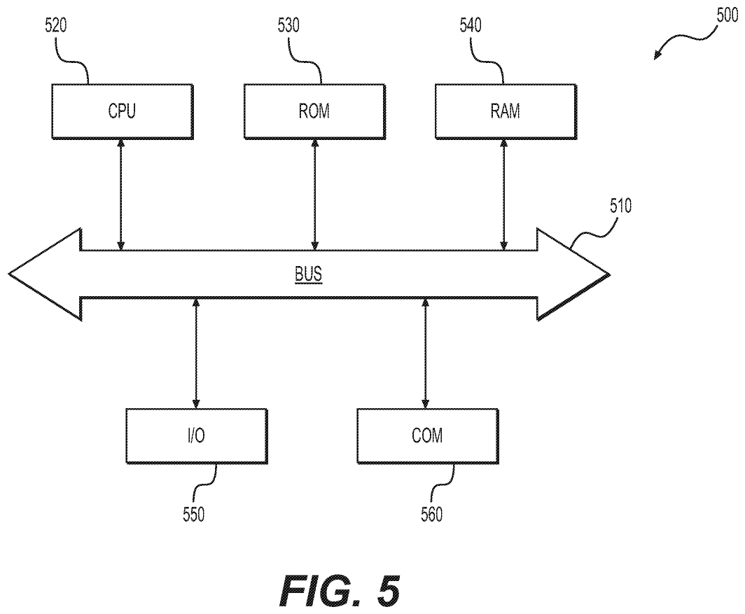

Environment 100 may include one or more computer systems configured to gather, process, transmit, and/or receive data. In general, whenever environment 100 is described as performing an operation of gathering, processing, transmitting, or receiving data, it is understood that such operation may be performed by a computer system thereof. In general, a computer system may include one or more computing devices, as described in connection with FIG. 5 below.

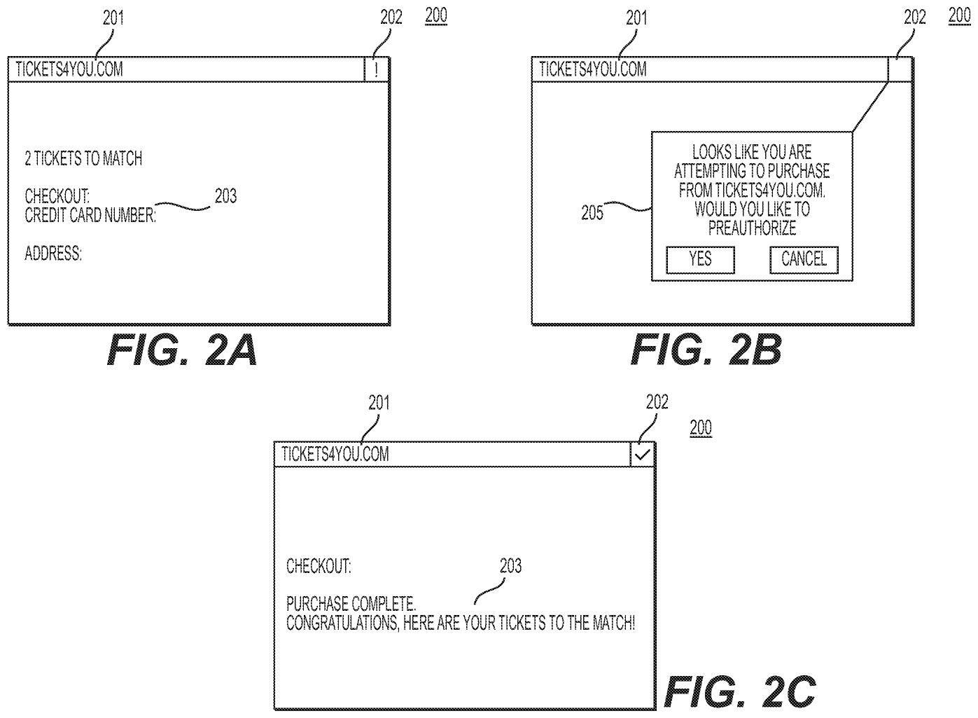

FIGS. 2A-2C depict exemplary user interfaces 200 for transaction pre-authorization using a browser extension, according to one aspect of the present disclosure. User interface 200 may be displayed in a web browser, e.g., Internet Explorer° , Chrome®, Safari®, Edge®, or may be an application implemented on the user device 105. User interface 200 may also have a browser extension, or other code or library extensions, installed to perform transaction pre-authorization. Browser extensions may be small software modules for customizing a web browser or an application. User interface 200 may include an address bar 201, extension interface 202, and transaction area 203, as depicted in FIG. 2A. Address bar 201 may display a Uniform Resource Locator (URL) of the vendor (also referred to as a merchant). Transaction area 203 may display information related to the product and/or service the user would like to purchase. Additionally, transaction area 203 may display shopping cart information such as input fields for the user to enter payment information. Extension interface 202 may display notifications regarding pre-authorization. Notifications regarding pre-authorization may be presented by symbols (e.g. “!”, “*”), text, colors (e.g., red), or any other indication to the user. As depicted in FIG. 2A, the exemplary user interface 200 indicates that the user is on the website of vendor “TICKETS4YOU.COM” and may be attempting to purchase 2 tickets to a sporting event. The browser extension may determine the vendor information from the address bar 201, and shopping cart information from transaction area 203 and may display a notification via extension interface 202 that transaction pre-authorization may be required, for example via a “!” symbol. The user may notice the notification for pre-authorization and interact with the notification, which may then direct the user to the interface as depicted in FIG. 2B.

As depicted in FIG. 2B, exemplary user interface 200 may include address bar 201, extension interface 202, and pre-authorization interface 205. If the browser extension determines that a transaction pre-authorization may be needed or advantageous before the transaction can be completed, the browser extension may display the pre-authorization interface 205 and request the user to pre-authorize the transaction. The pre-authorization interface 205 may be displayed as a pop-up window over the transaction area 203, or the pre-authorization interface 205 may be displayed inline using hypertext markup language (HTML) in the web browser within the transaction area 203. As depicted in FIG. 2B, the pre-authorization interface 205 may display “LOOKS LIKE YOU ARE ATTEMPTING TO PURCHASE FROM TICKETS4YOU.COM. WOULD YOU LIKE TO PREAUTHORIZE”, the user may interact with the “YES” button and proceed to pre-authorize, or may interact with the “CANCEL” button to cancel pre-authorization. If the user interacts with the “YES” button and proceeds to pre-authorize the transaction, then the user may be directed to the shopping cart to finish entering payment information and complete the transaction, as depicted in FIG. 2C.

As depicted in FIG. 2C, exemplary user interface 200 may include address bar 201, extension interface 202, and transaction area 203. The browser extension may have determined that the transaction has completed, and may indicate to the user via the extension interface 202 a notification that represents transaction completion. Notifications regarding transaction completion may be presented by symbols (e.g., check mark), text, colors (e.g., green), or any other indication to the user, including a lack of any display.

Although the examples discussed above involve a browser extension added to a browser, the browser may natively perform techniques discussed herein. These techniques may also be performed in an application, mobile device app, etc.

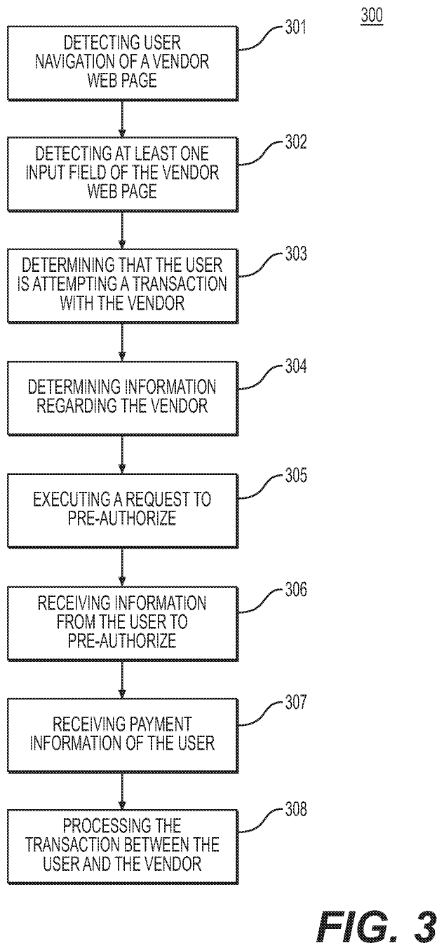

FIG. 3 depicts an exemplary flow diagram 300 for transaction pre-authorization, according to aspects of the present disclosure. Flow diagram 300 may begin at step 301 where a user may be navigating on a website of a vendor attempting to make a transaction. The web browser used by the user may have a browser extension installed that may be able to detect that the user is navigating the website. The browser extension may make the detection based on, for example, mouse movement or web page selection or other indication by the user.

The browser extension at step 302 may also detect at least one input field available on the web page or other interface of the vendor by reading the contents of the document object model (DOM) and examining for specific field labels (e.g., credit card number, cvv, expiration date, etc.). If one or more of these specific input fields are detected by the browser extension, then at step 303, the browser extension may determine that the user is attempting a transaction with the vendor. At step 304 the browser extension may determine information regarding the vendor. For example, the browser extension may read the address bar 201 or data embedded in the web pages to determine the name of the vendor and the location of the vendor. The browser extension may communicate with the issuer 140 to access the data stored in the vendor database 141 to determine if the vendor 130 is potentially outside of the country to which the user resides, if the vendor is a seller of high-risk items, or if the vendor is a seller of products or services that requires high monetary amounts (e.g., higher than a predetermined threshold).

Upon determining the vendor information at step 304, then at step 305 the browser extension may execute a request for the user to pre-authorize the transaction before the transaction is transmitted to the issuer 140 to process. The request for the user to pre-authorize the transaction may be in any of a plurality of formats. For example, the request may be in the form of a pop-up window on top of the web page of the vendor. In another aspect, the request may be injected into the current page of the vendor via HTML injection so that the request is displayed in line with the vendor website such that the user may be able to submit the request to pre-authorize without navigating away from the web page of the vendor. In a further aspect, the request may be an electronic mail sent to the user to which the user may respond. For example, the request may be a text message transmitted to the user device 105, an application notification sent to an application residing on the user device 105, and/or may be a link or URL to the issuer or a third party webpage where the user may enter their credentials. The request may also display a set of information to the user to explain the pre-authorization. For example, the request may include the vendor information such as name, time of the pre-authorization request, the amount of time the pre-authorization will be in effect, amount of the potential transaction, and any other information that may be necessary or useful for the user.

Upon notifying the user of a request to pre-authorize at step 305, at step 306 information may be received from the user to validate the pre-authorization with the issuer 140. Information received from the user may be used to verify the identity of the user and confirm the user has permission to confirm pre-authorization. Information received from user may include, the user's credentials for the issuer 140, a user name and password of the user, two-factor authentication (2FA), biometric information (e.g., fingerprint, or iris), or any other secure identification information known in the art. In such a manner, any required security standards may be upheld.

Once the user has successfully pre-authorized the transaction, then at step 307, payment and order information may be received from the user. For example, payment information may include credit card information, bank information, or payment application information. Upon receiving payment information, the transaction may be submitted to the issuer 140 at step 308. The issuer 140 may then process the transaction between the user and the vendor and complete the transaction. Once the transaction is completed, the user may be allowed to whitelist the vendor or adjust pre-authorization preference for the vendor. For example, by including the vendor in a whitelist, the user may indicate to the issuer 140 that a pre-authorization is not needed for the vendor, and transactions may be approved without fraud checks. In addition, by including the vendor in a whitelist, the issuer 140 may also automatically perform pre-authorization for the vendor in the future. The user may also adjust the amount of time or monetary amount allowed for the vendor, for example the user may indicate to the issuer 140 that the pre-authorization may be valid for a predetermined amount of time or monetary amount, so that the user may not have to pre-authorize for transactions within the predetermined amount of time or monetary amount. These adjustments or preferences may then be stored in the user database 142 and/or by the issuer 140.

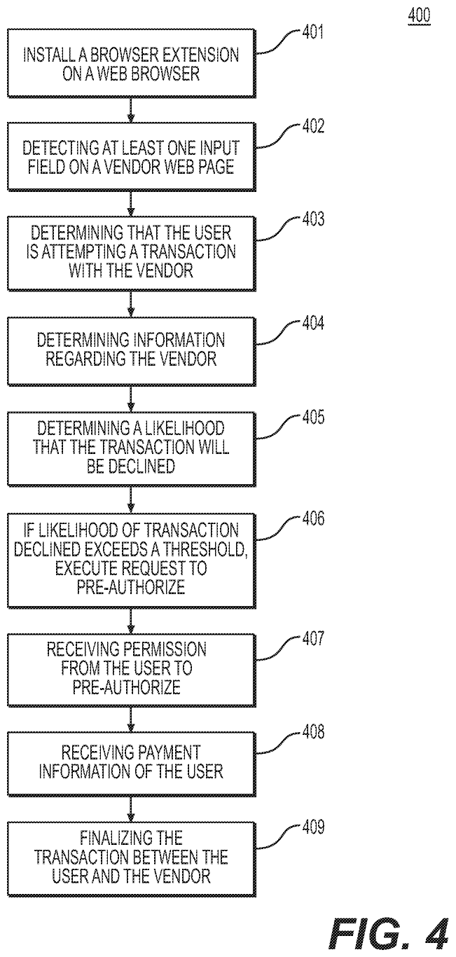

FIG. 4 depicts another exemplary flow diagram 400 for transaction pre-authorization using a browser extension, according to aspects of the present disclosure. Flow diagram 400 may begin at step 401 where the user may have a browser extension installed on the web browser residing on user device 105. The browser extension may be installed by the issuer 140, or the extension may be installed by the user, or the extension may be pre-installed by the manufacture of the user device 105.

Upon the installation of the browser extension at step 401, then at step 402, the browser extension may detect at least one input field available on the web page of the vendor by reading the contents of the document object model (DOM) and searching for specific field labels (e.g., credit card number, cvv, expiration date, etc.). If any one or more of these specific input fields are detected by the browser extension, then at step 403, the browser extension may determine that the user is attempting a transaction with the vendor. At step 404 the browser extension may determine information regarding the vendor. For example the browser extension may read the address bar 201 or data embedded in the web pages to determine the name of the vendor and the location of the vendor. The browser extension may communicate with the issuer 140 to access the data stored in the vendor database 141 to determine if the vendor is potentially outside of the country to which the user resides, if the vendor is a seller of high risk items, or if the vendor is a seller of products or services that require high monetary amounts.

Upon determining the vendor information at step 404, then at step 405, the browser extension may determine the likelihood that the transaction will be declined by considering factors regarding the transaction. For example, transactions that are consistent with normal (e.g., typical) spending habits of the user may have a low likelihood of being declined, however, transactions that are inconsistent with the normal spending habits of the user may have a high likelihood for being declined. Examples of transactions that are inconsistent with normal spending habits of the user may include transactions that exceed a typical monetary value for transactions of the user, or transactions of certain high risk products or services. Purchases from vendors who are international and/or vendors with high fraudulent purchases may also increase the likelihood of decline.

Upon determining the likelihood of decline for the transaction, then at step 406, the browser extension may determine if the transaction exceeds a certain threshold of likelihood of decline. When the browser extension determines that the transaction has a high likelihood of decline even though it may be a legitimate purchase, then the browser extension may execute a request for the user to pre-authorize the transaction before the transaction is transmitted to the issuer 140 to process. The request for the user to pre-authorize the transaction may be any of a plurality of formats. For example, the request may be in the form of a pop-up window on top of the web page of the vendor, may be injected into the current page of the vendor via HTML injection so that the request is displayed in line with the vendor website thereby enabling the user to submit the request to pre-authorize without navigating away from the web page of the vendor, may be an electronic mail sent to the user to which the user may respond (e.g., a text message to the user device 105), an application notification sent to an application residing on the user device 105, and/or a link or URL to the issuer or a third party webpage where the user may enter their credentials. The request may also display a set of information to the user to explain the pre-authorization. For example, the request may include the vendor information such as name, time of the pre-authorization request, the amount of time the pre-authorization will be in effect, amount of the potential transaction, and any other information that may be necessary or useful to the user.

Upon notifying the user of a request to pre-authorize at step 406, then at step 407, information may be received from the user to validate the pre-authorization with the issuer 140. Information received from the user may be used to verify the identity of the user and confirm the user has permission to confirm pre-authorization. Information received from user may include the user's credentials for the issuer 140, a user name and password of the user, two-factor authentication (2FA), biometric information (e.g., fingerprint, or iris), or any other secure identification information known in the art.

Once the user has successfully pre-authorized the transaction, then at step 408, payment and order information may be received from the user. For example, payment information may include credit card information, bank information, or payment application information. Upon receiving payment information, the transaction may be submitted to the issuer 140 at step 409. The issuer 140 may then process the transaction between the user and the vendor and complete the transaction. Once the transaction is completed, the user whitelist or adjust pre-authorization preferences for the vendor. For example, by including the vendor in a whitelist, the user may indicate to the issuer 140 that a pre-authorization is not needed for the vendor, and transactions may be approved without fraud checks. The user may also adjust the amount of time or monetary amount allowed for the vendor. For example, the user may indicate to the issuer 140 that the pre-authorization may be valid for a predetermined amount of time or monetary amount, so that the user may not be required to pre-authorize for transactions within the predetermined amount of time or monetary amount. These adjustments or preferences may then be stored in the user database 142 and/or by the issuer 140.

FIG. 5 depicts a high-level functional block diagram of an exemplary computer device or system, in which embodiments of the present disclosure, or portions thereof, may be implemented, e.g., as computer-readable code. In some implementations, the user device 105 depicted in FIG. 1 may correspond to device 500. Additionally, each of the exemplary computer servers, databases, user interfaces, modules, and methods described above with respect to FIGS. 1-4 can be implemented in device 500 using hardware, software, firmware, tangible computer readable media having instructions stored thereon, or a combination thereof and may be implemented in one or more computer systems or other processing systems. Hardware, software, or any combination of such may implement each of the exemplary systems, user interfaces, and methods described above with respect to FIGS. 1-4.

If programmable logic is used, such logic may be executed on a commercially available processing platform or a special purpose device. One of ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device.

For instance, at least one processor device and a memory may be used to implement the above-described embodiments. A processor device may be a single processor or a plurality of processors, or combinations thereof. Processor devices may have one or more processor “cores.”

Various embodiments of the present disclosure, as described above in the examples of FIGS. 1-4, may be implemented using device 500. After reading this description, it will become apparent to a person skilled in the relevant art how to implement embodiments of the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

As shown in FIG. 5, device 500 may include a central processing unit (CPU) 520. CPU 520 may be any type of processor device including, for example, any type of special purpose or a general-purpose microprocessor device. As will be appreciated by persons skilled in the relevant art, CPU 520 also may be a single processor in a multi-core/multiprocessor system, such system operating alone, or in a cluster of computing devices operating in a cluster or server farm. CPU 520 may be connected to a data communication infrastructure 510, for example, a bus, message queue, network, or multi-core message-passing scheme.

Device 500 also may include a main memory 540, for example, random access memory (RAM), and also may include a secondary memory 530. Secondary memory 530, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 530 may include other similar means for allowing computer programs or other instructions to be loaded into device 500. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 500.

Device 500 also may include a communications interface (“COM”) 560. Communications interface 560 allows software and data to be transferred between device 500 and external devices. Communications interface 560 may include a modem, a network interface (such as an Ethernet card), a communications port, a PCMCIA slot and card, or the like. Software and data transferred via communications interface 560 may be in the form of signals, which may be electronic, electromagnetic, optical, or other signals capable of being received by communications interface 560. These signals may be provided to communications interface 560 via a communications path of device 500, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 500 also may include input and output ports 550 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted except in light of the attached claims and their equivalents.

1. A computer-implemented method for pre-authorization using a web browser extension, the method comprising:
detecting, using the web browser extension executing on a user device associated with a user, user navigation by the user of a vendor web page, the vendor web page being associated with a vendor, wherein the web browser extension comprises software for customizing a web browser or an application;
detecting, using the web browser extension, at least one input field of the vendor web page;
determining, using the web browser extension, based on the at least one input field of the vendor web page, that the user is attempting a transaction with the vendor;
determining, using the web browser extension, information regarding the vendor based on data embedded in the vendor web page, wherein the information regarding the vendor includes a country of residence of the vendor;
determining, using the web browser extension, information regarding the user, wherein the information regarding the user includes a country of residence of the user;
comparing, using the web browser extension, the information regarding the vendor with the information regarding the user;
based on the comparison, automatically executing, using the web browser extension, a program to display a pre-authorization interface, wherein the pre-authorization interface comprises a request for the user to pre-authorize the transaction prior to completing the transaction;
receiving, using the web browser extension, an indication from the user to pre-authorize the transaction;
sending, using the web browser extension, a notification to an issuer that the transaction is pre-authorized prior to the issuer processing the transaction between the user and the vendor;
receiving, using the web browser extension, payment information of the user;
transmitting, using the web browser extension, the payment information of the user to the issuer;
receiving, using the web browser extension, information resulting from the issuer processing the transaction between the user and the vendor;
receiving, using the web browser extension, a predetermined time period or a predetermined monetary amount for which the transaction is pre-authorized; and
causing display, using the web browser extension, of the predetermined time period or the predetermined monetary amount for which the transaction is pre-authorized on the pre-authorization interface.

2. The computer-implemented method of claim 1, wherein the information regarding the vendor further includes cost and risk information associated with products or services offered by the vendor.

3. (canceled)

4. The computer-implemented method of claim 1, further including automatically redirecting, using the web browser extension, upon receiving the indication from the user to pre-authorize the transaction, the user to a vendor shopping cart web page to complete the transaction.

5. The computer-implemented method of claim 1, wherein the request for the user to pre-authorize the transaction displayed on the pre-authorization interface is in the form of a natural language statement.

6. The computer-implemented method of claim 1, wherein the information from the user to pre-authorize the transaction comprises an authorized time period limitation defining a time period for which the transaction is pre-authorized.

7. The computer-implemented method of claim 1, wherein the information from the user to pre-authorize the transaction includes an authorized monetary amount limitation defining a maximum monetary amount for which the transaction is pre-authorized.

8. The computer-implemented method of claim 1, wherein the information from the user to pre-authorize the transaction includes at least one of password information, two factor authentication information, or biometric information.

9. The computer-implemented method of claim 1, wherein the at least one input field includes at least one of credit card expiration date, credit card number, or credit card verification value (cvv) number.

10. The computer-implemented method of claim 1, further including comparing, using the web browser extension, the information regarding the vendor with a user's vendor whitelist.

11. A computer system for pre-authorization, the computer system being associated with a user, comprising:
at least one memory having processor-readable instructions and a web browser extension stored therein; and
at least one processor configured to access the memory and execute the processor-readable instructions, which when executed by the processor configures the processor to perform a plurality of functions, including functions for:
detecting, using the web browser extension executing on the computer system associated with the user, user navigation by the user of a vendor web page, the vendor web page being associated with a vendor;
detecting, using the web browser extension, at least one input field of the vendor web page;
determining, using the web browser extension, based on the at least one input field of the vendor web page, that the user is attempting a transaction with the vendor;
determining, using the web browser extension, information regarding the vendor based on data embedded in the vendor web page, wherein the information regarding the vendor includes a country of residence of the vendor;
determining, using the web browser extension, information regarding the user, wherein the information regarding the user includes a country of residence of the user;
comparing, using the web browser extension, the information regarding the vendor with the information regarding the user;
based on the comparison, automatically executing, using the web browser extension, a program to display a pre-authorization interface, wherein the pre-authorization interface comprises a request for the user to pre-authorize prior to completing the transaction;
receiving, using the web browser extension, an indication from the user to pre-authorize the transaction;
sending, using the web browser extension, a notification to an issuer that the transaction is pre-authorized prior to the issuer processing the transaction between the user and the vendor;
receiving, using the web browser extension, payment information of the user;
transmitting, using the web browser extension, the payment information of the user to the issuer;
receiving, using the web browser extension, information resulting from the issuer processing the transaction between the user and the vendor;
receiving, using the web browser extension, a predetermined time period or a predetermined monetary amount for which the transaction is pre-authorized; and
notifying the user, using the web browser extension, of the predetermined time period or the predetermined monetary amount for which the transaction is pre-authorized.

12. The computer system of claim 11, wherein the information regarding the vendor further includes cost and risk information associated with products or services offered by the vendor.

13. The computer system of claim 11, wherein the functions further include comparing the information regarding the vendor with a user's vendor whitelist.

14. The computer system of claim 11, wherein the functions further include upon receiving the indication from the user to pre-authorize the transaction, automatically redirecting, using the web browser extension, the user to a vendor shopping cart web page to complete the transaction.

15. The computer system of claim 11, wherein the request for the user to pre-authorize the transaction displayed on the pre-authorization interface is in the form of a natural language statement.

16. The computer system of claim 11, wherein the information from the user to pre-authorize the transaction comprises an authorized time period limitation defining a time period for which the transaction is pre-authorized.

17. The computer system of claim 11, wherein the information from the user to pre-authorize the transaction includes an authorized monetary amount limitation defining a maximum monetary amount for which the transaction is pre-authorized.

18. The computer system of claim 11, wherein the information from the user to pre-authorize the transaction includes at least one of password information, two factor authentication information, or biometric information.

19. The computer system of claim 11, wherein the at least one input field includes at least one of credit card expiration date, credit card number, or credit card verification value (cvv) number.

20. A computer-implemented method for pre-authorization using a browser extension, the method comprising:
detecting, using the browser extension executing on a user device associated with a user, at least one input field on a web page of a vendor;
determining, using the browser extension, based on the at least one input field of the web page that the user is attempting a transaction with the vendor;
determining, using the browser extension, information regarding the user;
determining, using the browser extension, information regarding the vendor based on the web page of the vendor;
determining, using the browser extension, a likelihood that the transaction will be declined based on the at least one input field, the information regarding the user, and the information regarding the vendor;
based on the determination of the likelihood that the transaction will be declined, automatically causing display, using the browser extension, of a pre-authorization interface, wherein the pre-authorization interface comprises a request for the user to pre-authorize the transaction with an issuer;
receiving, using the browser extension, permission from the user to pre-authorize the transaction; and
upon receiving permission from the user to pre-authorize the transaction, automatically redirecting, using the browser extension, the user to a vendor shopping cart web page to complete the transaction.
